(19) United States
(12) Patent Application Publication
(10) Pub. No.: US 2010/0061353 A1
(43) Pub. Date: Mar. 11, 2010

(54) ULTRA WIDEBAND ETHERNET BRIDGING APPARATUS AND METHOD

(75) Inventors: Jong Moo SOHN, Daejeon-city (KR); Jae Doo Hun, Daejeon-city (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon-city (KR)

(21) Appl. No.: 12/464,201

(22) Filed: May 12, 2009

(30) Foreign Application Priority Data
Sep. 9, 2008 (KR) 10-2008-0088892

(51) Int. Cl. H04W 8/00; H04B 1/69

(52) U.S. Cl. 370/338; 375/130; 375/E01.001; 370/466

(57) ABSTRACT

Provided is an ultra wideband (UWB) Ethernet bridging apparatus and method. The UWB Ethernet bridging apparatus differentiates control frames and data frames from one another and transmits the differentiated frames to the different internal path. A processor processes the control frames, and the data frame is processed by using separate hardware so that the UWB Ethernet bridging apparatus can be miniaturized/simplified by using a small-sized embedded processor that is cheap and has low performance.

### CROSS-REFERENCE TO RELATED PATENT APPLICATIONS

This application claims the benefit of Korean Patent Application No. 10-2008-0088892, filed on Sep. 9, 2008, in the Korean Intellectual Property Office, the disclosure of which is incorporated herein in its entirety by reference.

### BACKGROUND OF THE INVENTION

1. Field of the Invention

The present invention relates to an ultra wideband (UWB) Ethernet bridging apparatus and method, and more particularly, to a UWB Ethernet bridging apparatus which connects a wireless personal area network (WPAN) and a local area network (LAN), and a UWB Ethernet bridging method.

2. Description of the Related Art

WiMedia ultra wideband (UWB) technology, which is a recently focused-on wireless communication technology for wireless personal area networks (WPANs), includes an Internet protocol (IP)-based communication function as a protocol adaptation layer (PAL) called WiMedia logical link protocol (WLP) as a standard requirement of the WiMedia UWB technology, so as to increase technology utility. In addition, WiMedia UWB technology supports interconnecting with a LAN that is represented by the Ethernet by adding the concept of a WLP bridge to standard requirements of WiMedia UWB technology so as to enlarge Internet protocol (IP)-based communication areas. Since, the WLP bridge that is essential for IP-based interconnecting in the WPAN and the LAN must perform mutual protocol conversion on the WLP and the IEEE 802.3, 802.1d, and 802.1Q standards, which are specific functions of a general Ethernet bridge, the WLP bridge has a different structure from that of an interface conversion apparatus having a single port.

FIG. 1 illustrates a conventional apparatus for converting two or more different protocols. Referring to FIG. 1, the conventional apparatus for converting two or more different protocols includes a processor 100 connected to each of a plurality of communication interfaces 130, 132, 134, and 136. The processor 100 includes a protocol conversion unit 110, a filtering unit 112, a bridging unit 114, and a plurality of protocol stacks 120, 122, and 124 connected to each of the communication interfaces 130, 132, 134, and 136. The protocol conversion unit 110, the filtering unit 112, and the bridging unit 114 of the processor 100 are all implemented by using software. Each of the communication interfaces 130, 132, 134, and 136 connected to the processor 100 may be of the same or different type.

The conventional apparatus for converting two or more different protocols processes the information from each received data frame or control frame, by using software. Thus, the conventional apparatus has an advantage in that it easily supports a variety of interfaces. However, in the conventional apparatus, conditional filtering and forwarding, as well as simple protocol processing and data format conversion, must be performed by software. Thus, an increase in the types or number of interfaces causes a limitation in performance.

For example, when a WLP bridge apparatus that requires WiMedia UWB and Ethernet is implemented by using the conventional apparatus shown in FIG. 1, the number of virtual bridge ports that must be generated by the WLP bridge apparatus increases. As such, a load that occurs when searching rules for filtering and forwarding increases, and bridge performance is degraded.

In addition, a high performance processor is required to support multiple interfaces with transmission rates of several hundreds of Mbps or more, as in WiMedia UWB technology or Gigabyte Ethernet. Thus, it is difficult to miniaturize and simplify a bridging apparatus.

### SUMMARY OF THE INVENTION

The present invention provides an ultra wideband (UWB) Ethernet bridging apparatus which removes a limitation in the performance of a software-based bridge structure and supports a plurality of high-speed interfaces for a wireless personal area network (WPAN) and a local area network (LAN), and a UWB Ethernet bridging method.

According to an aspect of the present invention, there is provided an ultra wideband (UWB) Ethernet bridging apparatus, including: an UWB interface unit transmitting and receiving a UWB frame; an Ethernet interface unit transmitting and receiving an Ethernet frame; a frame conversion unit converting a format of the UWB frame into a format of the Ethernet frame; and a frame multiplexing/demultiplexing unit transmitting the UWB frame received by the UWB interface unit to the frame conversion unit if the UWB frame is a UWB data frame, or transmitting the UWB frame to a processor that exists on a separate path from an internal transmission path of the UWB data frame if the UWB frame is not the UWB data frame.

According to another aspect of the present invention, there is provided an ultra wideband (UWB) Ethernet bridging method, including: receiving a UWB frame; if the UWB frame is a UWB data frame, converting a format of the UWB frame into a format of an Ethernet frame; if the UWB frame is not a UWB data frame, transmitting the UWB frame to a processor that exists on a separate path from an internal transmission path of the UWB data frame; and forwarding the Ethernet frame to Ethernet.

According to another aspect of the present invention, there is provided an ultra wideband (UWB) Ethernet bridging method, including: receiving an Ethernet frame; converting a format of the Ethernet frame into a format of a UWB frame; and if a destination address of the UWB frame is a multicast or broadcast address or if the UWB frame is a frame associated with a device that is not registered in a UWB service, transmitting the UWB frame.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional apparatus for converting two or more different protocols;

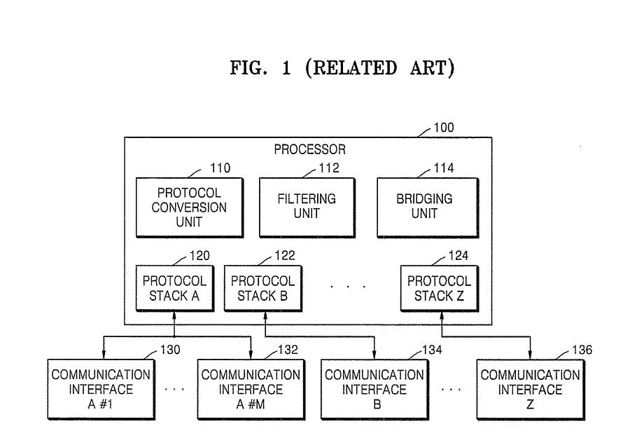

FIG. 2 illustrates an ultra wideband (UWB) Ethernet bridging apparatus according to an embodiment of the present invention;

FIG. 3 illustrates a UWB Ethernet bridging apparatus according to another embodiment of the present invention;

FIG. 4 is a flowchart illustrating an operation of processing a WiMedia logical link protocol (WLP) frame that is received through UWB communication in the UWB Ethernet bridging apparatus illustrated in FIG. 2 or 3, according to an embodiment of the present invention; and

FIG. 5 is a flowchart illustrating an operation of processing a WLP frame that is received through the Ethernet in the UWB Ethernet bridging apparatus illustrated in FIG. 2 or 3, according to another embodiment of the present invention.

### DETAILED DESCRIPTION OF THE INVENTION

Hereinafter, exemplary embodiments of the present invention will be described in detail with reference to the accompanying drawings.

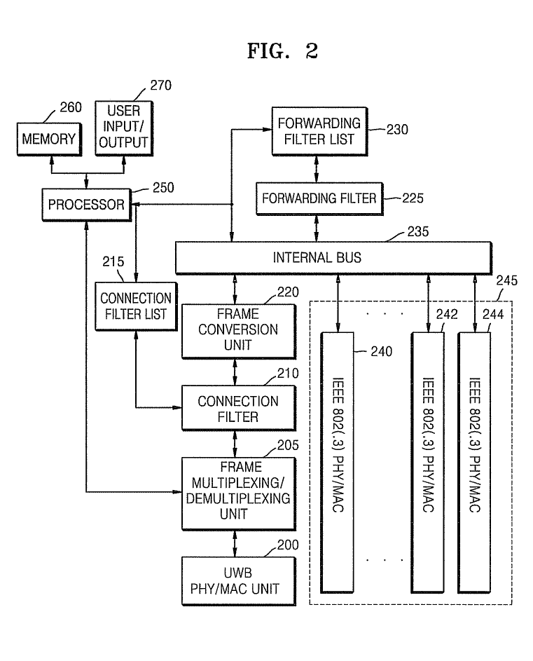

FIG. 2 illustrates an ultra wideband (UWB) Ethernet bridging apparatus according to an embodiment of the present invention. Referring to FIG. 2, the UWB Ethernet bridging apparatus according to the current embodiment includes a UWB physical/media access control (PHY/MAC) unit 200 which is a UWB interface, a frame multiplexing/demultiplexing unit 205, a connection filter 210, a connection filter list 215, a frame conversion unit 220, a forwarding filter 225, a forwarding filter list 230, an internal bus 235, one or more IEEE 802 PHY/MAC units 245, each of which is an Ethernet interface, a processor 250, a memory 260, and a user input/output unit 270.

The UWB PHY/MAC unit 200 transmits and receives a plurality of UWB frames to and from devices having standard requirements of WiMedia UWB, which is one of a plurality of UWB methods.

The frame multiplexing/demultiplexing unit 205 determines whether the UWB frame transmitted by the UWB PHY/MAC unit 200 is a UWB data frame. Here, the UWB data frame is a protocol data frame having a specific name and using a UWB. However, so as not to be limited to a specific protocol, the UWB data frame is referred to. For example, the UWB data frame may imply a WLP data frame in a previously-defined WiMedia UWB environment. The WLP data frame includes a 2-byte protocol identifier (ID) field and a 1-byte WLP frame type field. Thus, the frame multiplexing/demultiplexing unit 205 classifies the UWB frame as a WLP data frame based on the WLP frame type field.

When the UWB frame is a UWB data frame, the frame multiplexing/demultiplexing unit 205 transmits the UWB frame to the connection filter 210. When neither of the UWB frame is a protocol frame that is compatible with Ethernet nor a data frame, even though the UWB frame is compatible with the Ethernet, i.e., when the UWB frame is a frame for protocol control or association, the frame multiplexing/demultiplexing unit 205 transmits the UWB frame to the processor 250.

In other words, the processor 250 interchanges information that is necessary for association with external UWB devices by using association frames and various control frames and performs association. For example, the processor 250 performs initial WLP association that is defined in the WiMedia UWB standard. When the UWB Ethernet bridging apparatus is connected to a UWB device, the UWB Ethernet bridging apparatus and the UWB device differentiate data frames to be bridged, by using a UWB service ID. For example, when, in a WiMedia UWB environment, a frame is a WLP frame, the UWB Ethernet bridging apparatus and the UWB device differentiate data frames to be bridged, by using a common logical ID such as WLP service set (WSS).

The processor 250 obtains a UWB service ID (in the case of the WLP frame, a WSS ID) through an initial UWB association operation and stores the UWB service ID in the connection filter list 215 together with an address of the UWB device. In addition, the processor 250 deletes an item related to the UWB device from the connection filter list 215 when the UWB Ethernet bridging apparatus is disconnected from the UWB device.

The processor 250 may interchange various rules for bridging by using additional control frames after the UWB Ethernet bridging apparatus is connected to the UWB device, and the UWB device may add or remove the rules in a desired format to and from the forwarding filter list 230.

When receiving the UWB data frame from the frame multiplexing/demultiplexing unit 205, the connection filter 210 looks up the connection filter list 215 by using a UWB service ID and a source address of the UWB data frame and transmits the UWB data frame to the frame conversion unit 220 only when the UWB data frame has been already registered. When look-up of the connection filter list 215 by using the UWB service ID and the source address of the UWB data frame fails, the connection filter 210 discards the UWB data frame. When a destination address of the UWB data frame is a multicast or broadcast address, the connection filter 210 transmits the UWB data frame directly to the frame conversion unit 220 without looking up the UWB data frame.

When receiving the UWB data frame from the connection filter 210, the frame conversion unit 220 converts a format of the UWB data frame into a format of a frame that is defined in the IEEE 802 standard by using a source/destination address and a payload of the UWB data frame and transmits the converted frame to the forwarding filter 225 via the internal bus 235.

The forwarding filter 225 looks up the forwarding filter list 230 based on one or more of parameters, such as a virtual LAN (VLAN) ID of a frame, a protocol ID, and a destination address, and forwards or discards the converted Ethernet frame according to a result of looking up the forwarding filter list 230. When the forwarding filter 225 forwards the converted Ethernet frame, the forwarding filter 225 transmits the converted Ethernet frame to the IEEE 802 PHY/MAC units 245 via the internal bus 235.

Above, the operation and function of each configuration when the UWB frame received from the UWB device is output through the Ethernet have been described. Hereinafter, the operation and function of each configuration when the Ethernet frame received from the Ethernet is output to the UWB device will be described.

The IEEE 802 PHY/MAC units 245 transmit the Ethernet frame that is received through a wired/wireless LAN to the forwarding filter 225 via the internal bus 235. The forwarding filter 225 looks up the forwarding filter list 230 based on one or more of parameters, such as a VLAN ID of a frame, a protocol ID, and a destination address and determines whether the Ethernet frame is to be forwarded or discarded according to a result of looking up the forwarding filter list 230. When the forwarding filter 225 forwards the Ethernet frame, the forwarding filter 225 transmits the Ethernet frame to the frame conversion unit 220 via the internal bus 235.

When receiving the Ethernet frame via the internal bus 235, the frame conversion unit 220 converts a format of an Ethernet frame into a format of an UWB frame by using a source/destination address and a payload of the Ethernet frame. In this case, the frame conversion unit 220 uses a UWB service ID that is obtained by performing association with the UWB device. The connection filter 210 looks up the connection filter list 215 by using the UWB service ID and the destination address of the frame converted by the frame conversion unit 220 and transmits the converted frame to the UWB PHY/MAC unit 200 only when the converted frame has been already registered.

According to another embodiment of the present invention, the case where the UWB Ethernet bridging apparatus according to the present invention supports an additional Ethernet protocol, i.e., a spanning tree protocol (STP) or a rapid spanning tree protocol (RSTP), for supporting the IEEE 802.1d standard will now be described. First, when a control frame of an STP or a RSTP is transmitted to the internal bus 235, the internal bus 235 transmits the control frame to the processor 250 together with input port information. The processor 250 determines an operating mode of a bridge so as to satisfy standard requirements of a protocol of the control frame. The processor 250 converts a state of each of network ports into an active/inactive state by using information corresponding to the determined operating mode and operates as a blocked portion (BP) that is defined in the STP.

Items other than the items described in the current embodiment, may be used in direct data transmission and reception between the internal bus 235 and the processor 250 and in look-up of filters.

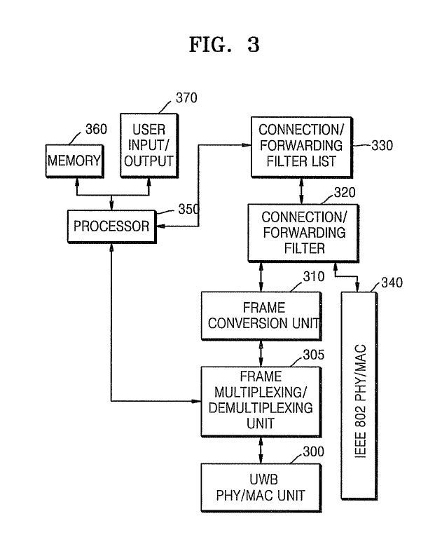

FIG. 3 illustrates a UWB Ethernet bridging apparatus according to another embodiment of the present invention. In particular, FIG. 3 illustrates a UWB Ethernet bridging apparatus including one Ethernet port unlike the embodiment of FIG. 2 in which a plurality of Ethernet ports are disposed.

Referring to FIG. 3, the UWB Ethernet bridging apparatus according to the current embodiment includes a UWB PHY/MAC unit 300, a frame multiplexing/demultiplexing unit 305, a frame conversion unit 310, a connection/forwarding filter 320, a connection/forwarding filter list 330, an IEEE 802 PHY/MAC unit 340, a processor 350, memory 360, and a user input/output unit 370.

The UWB PHY/MAC unit 300 performs UWB communication with external UWB devices, and the frame multiplexing/demultiplexing unit 305 multiplexes/demultiplexes a plurality of UWB data frames, a plurality of frames for IEEE 802.1d MAC bridging control, and other frames by differentiating between them. The frame conversion unit 310 performs a mutual conversion function between a UWB frame format and an IEEE 802.3 frame format. The connection/forwarding filter 320 filters frames to be bridged if related information such as the UWB service (in the case of the WLP frame, a WSS service) has not been registered in the connection/forwarding filter list 330. The processor 350 performs UWB connection control, UWB service (in the case of the WLP frame, a WSS service) management, and bridge management.

In this way, the apparatus of FIG. 3 has a similar structure to that of the apparatus of FIG. 2 and performs a similar operation to that of FIG. 2. However, the apparatus of FIG. 3 includes one IEEE 802 PHY/MAC unit 340 and thus, the internal bus 235 of FIG. 2 may be omitted in the current embodiment. However, as the internal bus 235 is not shown, a path on which control frames for supporting an IEEE 802.16d MAC bridging function are transmitted to the processor 350 disappears. To this end, a path between the frame multiplexing/demultiplexing unit 350 and the processor 350 is used. In addition, the connection/forwarding filter 320 performs filter processing in which a comparatively complex hardware circuit is needed, so that the area of the circuit or power consumption can be reduced.

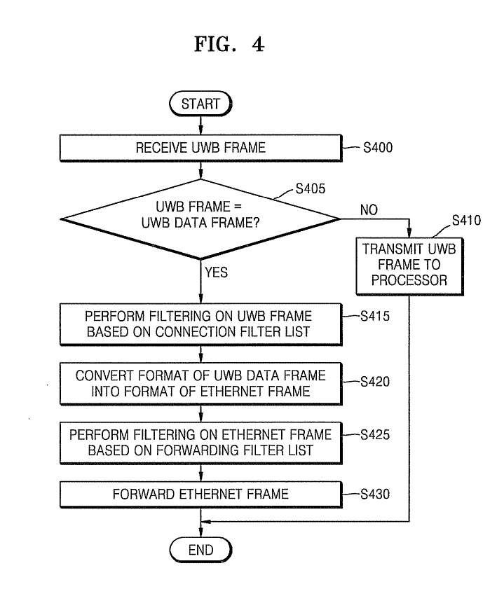

FIG. 4 is a flowchart illustrating an operation of processing a WiMedia logical link protocol (WLP) frame that is received through UWB communication in the UWB Ethernet bridging apparatus illustrated in FIG. 2 or 3, according to an embodiment of the present invention. Referring to FIG. 4, when receiving a UWB frame in operation S400, the UWB Ethernet bridging apparatus checks whether the UWB frame is a UWB data frame in operation S405. When the received UWB frame is determined to not be a UWB data frame, in operation S410, the UWB Ethernet bridging apparatus transmits the UWB frame to a processor so that the processor can process the UWB frame. For example, when the received UWB frame is a connection control frame, an operation, such as storing a UWB service ID that is obtained by performing generating, processing, and connecting of frames related to connection control, is performed by an additional processor in the UWB Ethernet bridging apparatus.

When the received UWB frame is determined to be a UWB data frame in operation S405, in operation S415, the UWB Ethernet bridging apparatus performs filtering on the UWB frame based on a connection filter list in which the UWB service ID that is checked by performing an association operation with the UWB device, is stored. For example, when, in a WiMedia UWB environment, the UWB frame is a WLP frame, the UWB Ethernet bridging apparatus discards the UWB frame when a WSS ID of the WLP data frame is not stored in the connection filter list.

In operation S420, the UWB Ethernet bridging apparatus converts a format of the UWB data frame on which filtering is performed, into a format of an Ethernet frame. In operation S425, the UWB Ethernet bridging apparatus filters the converted Ethernet frame based on a forwarding filter list. In operation S430, the UWB Ethernet bridging apparatus transmits the Ethernet frame to the Ethernet.

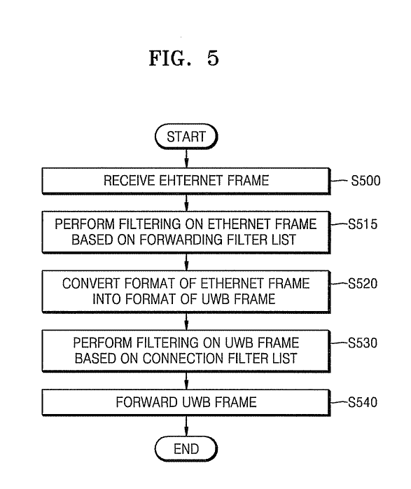

FIG. 5 is a flowchart illustrating an operation of processing a WLP frame that is received through the Ethernet in the UWB Ethernet bridging apparatus illustrated in FIG. 2 or 3, according to another embodiment of the present invention. Referring to FIG. 5, when receiving an Ethernet frame in operation S500, the UWB Ethernet bridging apparatus filters the Ethernet frame based on a forwarding filter list in operation S515. In operation S520, the UWB Ethernet bridging apparatus converts a format of the Ethernet frame on which filtering is performed, into a format of a UWB frame. In operation S530, the UWB Ethernet bridging apparatus filters the converted UWB frame based on a connection filter list. In operation S540, the UWB Ethernet bridging apparatus transmits the UWB frame to a corresponding UWB device.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, in the UWB Ethernet bridging apparatus according to the present invention, control frames and data frames are differentiated from one another, and a small-sized embedded processor that is cheap and has low performance is used such that the UWB Ethernet bridging apparatus can be miniaturized and/or simplified. In addition, the UWB Ethernet bridging apparatus can support a plurality of high-speed interfaces without degradation of performance.

While this invention has been particularly shown and described with reference to exemplary embodiments thereof, it will be understood by those of ordinary skill in the art that various changes in form and details may be made therein without departing from the spirit and scope of the invention as defined by the appended claims. Therefore, the scope of the invention is defined only by the appended claims, and all differences within the scope will be construed as being included in the present invention.

What is claimed is:

1. An ultra wideband (UWB) Ethernet bridging apparatus, comprising:
an UWB interface unit transmitting and receiving a UWB frame;
an Ethernet interface unit transmitting and receiving an Ethernet frame;
a frame conversion unit converting a format of the UWB frame into a format of the Ethernet frame; and
a frame multiplexing/demultiplexing unit transmitting the UWB frame received by the UWB interface unit to the frame conversion unit if the UWB frame is a UWB data frame, or transmitting the UWB frame to a processor that exists on a separate path from an internal transmission path of the UWB data frame if the UWB frame is not the UWB data frame.

2. The apparatus of claim 1, wherein, if the UWB frame is a control frame for association, the processor performs UWB association with a plurality of UWB devices and manages UWB service identifiers (IDs) and information about addresses of the UWB devices that are obtained as a result of UWB association.

3. The apparatus of claim 1, wherein the processor performs a control operation according to a protocol of the Ethernet frame received by the Ethernet interface unit.

4. The apparatus of claim 1, wherein the frame multiplexing/demultiplexing unit checks whether the UWB frame is a UWB data frame based on a protocol ID and a frame type of the UWB frame.

5. The apparatus of claim 1, further comprising a filtering unit discarding the UWB data frame when a destination address of the UWB data frame is not a multicast or broadcast address and the UWB data frame is a frame associated with a device that is not registered in a UWB service.

6. The apparatus of claim 1, further comprising:
a connection filter list storing a UWB service ID that is obtained by performing association with the UWB devices by using the processor, in connection with the information about addresses of the UWB devices; and
a connection filter discarding the UWB data frame when there is no information as a result of looking up the connection filter list based on the UWB service ID and a source address of the UWB data frame.

7. The apparatus of claim 1, further comprising a filtering unit determining whether the Ethernet frame is to be forwarded or discarded according to predetermined forwarding rules.

8. The apparatus of claim 1, further comprising:
a forwarding filter list storing predetermined forwarding rules; and
a forwarding filter determining the Ethernet frame is to be forwarded or discarded, by using the forwarding filter list.

9. The apparatus of claim 1, further comprising an internal bus connecting the frame conversion unit and the Ethernet interface unit, wherein the Ethernet interface unit comprises at least two or more ports connected to the internal bus.

10. An ultra wideband (UWB) Ethernet bridging method, comprising:
receiving a UWB frame;
if the UWB frame is a UWB data frame, converting a format of the UWB frame into a format of an Ethernet frame;
if the UWB frame is not a UWB data frame, transmitting the UWB frame to a processor that exists on a separate path from an internal transmission path of the UWB data frame; and
forwarding the Ethernet frame to Ethernet.

11. The method of claim 10, further comprising, if a destination address of the UWB data frame is not a multicast or broadcast address and the UWB data frame is a frame associated with a device that is not registered in a UWB service, discarding the UWB data frame.

12. The method of claim 10, further comprising, if there is no information as a result of looking up a connection filter list in which a UWB service identifier (ID) and information about an address of a UWB device that are obtained by performing an initial UWB association operation by using the processor are stored, discarding the UWB data frame.

13. The method of claim 10, further comprising determining whether the Ethernet frame is to be forwarded or discarded according to predetermined forwarding rules.

14. An ultra wideband (UWB) Ethernet bridging method, comprising:
receiving an Ethernet frame;
converting a format of the Ethernet frame into a format of a UWB frame; and
if a destination address of the UWB frame is a multicast or broadcast address or if the UWB frame is a frame associated with a device that is not registered in a UWB service, transmitting the UWB frame.

15. The method of claim 14, wherein the transmitting of the UWB frame is performed if there is no information as a result of looking up a connection filter list in which a UWB service identifier (ID) and information about an address of a UWB device that are obtained by performing an initial UWB association operation by using the processor are stored.

16. The method of claim 14, further comprising determining whether the Ethernet frame is to be forwarded or discarded according to predetermined forwarding rules.
